(19) United States
(12) Patent Application Publication
(10) Pub. No.: US 2016/0017969 A1
(43) Pub. Date: Jan. 21, 2016

(54) SPLIT MOLDED INTEGRATED STATOR

(71) Applicant: EXEDY Corporation, Osaka (JP)

(72) Inventors: Kouzou Mori, Neyagawa-Shi (JP); Tatsuyuki Aoki, Neyagawa-shi (JP)

(73) Assignee: EXEDY CORPORATION, Osaka (JP)

(21) Appl. No.: 14/796,187

(22) Filed: Jul. 10, 2015

(30) Foreign Application Priority Data
Jul. 18, 2014 (JP) 2014-147629
Jun. 22, 2015 (JP) 2015-124667

(51) Int. Cl. F16H 41/26; F16H 45/00

(52) U.S. Cl. CPC F16H 41/26; F16H 45/00; F16H 2041/285

(57) ABSTRACT

A stator according to the present invention includes a stator hub, a large number of blades radially provided in a projecting manner at regular intervals on an outer periphery of the stator hub, and a stator core formed so as to surround outer ends of the respective blades. The stator is integrated by separately molding a front side stator member and a rear side stator member as two axially split members, respectively, and then joining the front side stator member and the rear side stator member.

### BACKGROUND OF THE INVENTION

1. Field of the Invention

The present invention relates to a stator to be used mainly for a torque converter in an automobile and the like.

2. Description of the Related Art

A stator in a torque converter of an automobile is disposed between a turbine runner located on an engine side and a pump impeller located on a transmission side. Moreover, the stator has a function of amplifying torque on the engine side by controlling the flow of oil circulating between the turbine runner and pump impeller to efficiently apply oil on the turbine runner side to the pump impeller side.

As shown in FIG. 8 and FIG. 9, commonly, a stator 41 is cast molded using an aluminum alloy or the like and integrated in whole. Specifically, the stator 41 includes a stator hub 43 fixed to an outer periphery of a one-way clutch 42 for supporting on a stationary shaft (not shown), a stator core 44 formed out of the stator hub 43, blades 45 in predetermined shapes provided, between the stator core 44 and the stator hub 43, radially at regular intervals in a circumferential direction of the stator core 44 and the stator hub 43. Also, a retainer 46 is attached to a front side of the one-way clutch 42.

As shown in FIG. 10, a wing section (sectional shape of a wing) of the blade 45 in the stator 41 has been provided with a radius of curvature of a camber line CL set larger than that shown in the drawing to thereby enhance the rotation of the pump impeller in order to increase the torque amplifying function of the stator 41.

In addition to the above, various stators are also known which are structured such that, in order to perform a series of torque transmissions from the time of idling to the time of starting of an automobile efficiently and actively, by dividing each blade into two front and rear members and varying the front side wing member and rear side wing member in positional relationship, the camber line CL and wing section are changed according to the situation so as to appropriately control hydraulic oil in the circulation channel area.

As shown in FIG. 11, commonly, in an injection molding die for molding a stator, inserts 53 and 54 are disposed within a pair of holders 51 and 52, respectively, and a cavity C for molding a stator in a predetermined shape is formed between the inserts 53 and 54. Then, merely moving the holders 51 and 52 in an axial direction A, B (die stroke direction) of said molding die after molding a stator in a predetermined shape allows releasing the stator from the die (hereinafter, referred to as “axial releasing molding”).

However, in the case of a stator including blades having a large radius of curvature of the camber line CL described above, simply moving the holders 51 and 52 in the axial direction A, B of said molding die as described above results in a situation of a die releasing failure due to a part of the blades being caught on the insert 53, 54.

Therefore, as shown in FIG. 12, it has been necessary to dispose sliding cores 65 for forming respective blades of a stator between insert dies 63 and 64 within a pair of holders 61 and 62 in large numbers in a circumferential direction and mold a stator hub and blades in the cavity C, and then move the holders 61 and 62 in an axial direction A, B and cause a releasing movement of the respective sliding cores 65 in a radial direction D, E (direction orthogonal to a die stroke direction) (hereinafter, referred to as “radial releasing molding”). However, such radial releasing molding has had a drawback that it requires a great deal of labor for the molding operation as compared with that in the case of axial releasing molding described above. Also, after such radial releasing molding, because it is further necessary to wrap a band in a manner surrounding outer ends of the respective blades radially projecting from an outer periphery of the molded stator hub so as to form an annular stator core, there has been a problem that a great deal of time and cost is required for manufacturing in combination with labor of the radial releasing molding operation described above.

Also in the stators in which each blade is divided into two members, similar to the foregoing, there has been a drawback that a great amount of labor and time is required for a molding operation and final finishing operation.

### BRIEF SUMMARY OF THE INVENTION

At least one object of the present invention is to enable axial releasing molding of a stator even when a radius of curvature of a camber line of its wind section (sectional shape of a wing) is large.

Also, an object of the present invention is, when the camber line is increased in radius of curvature in order to increase the torque amplifying function of a stator, to obtain an integrated stator by merely joining a front side stator member and a rear side stator member respectively obtained by axial releasing molding.

Further, another object of the present invention is to obtain a stator the camber line of which has a large radius of curvature by a method other than conventional radial releasing molding.

Still another object of the present invention is to manufacture a stator having a large radius of curvature of a camber line of a wind section without requiring a great deal of labor, time, and cost.

The present invention provides the following stator and a method for manufacturing the same and a torque converter including the stator.

That is, the present invention is a split molded integrated stator being a stator including a stator hub, a large number of blades radially provided in a projecting manner at regular intervals on an outer periphery of the stator hub, and a stator core formed so as to surround outer ends of the respective blades, for which a front side stator member and a rear side stator member are respectively separately molded as two axially split members, and the front side stator member and the rear side stator member are jointed to be integrated.

Also, an aspect of the present invention is a split molded integrated stator in which, as a splitting form into the front side stator member and the rear side stator member, the stator core and the blade are longitudinally split in a radial direction in a manner divided into two nearly equal front and rear parts and divided into a front side stator core member and a rear side stator core member and into a front side blade member and a rear side blade member, and the stator hub on an inner peripheral side has one of the front and rear side stator hub members in a range extending from an upper central part to an upper corner portion of the stator hub and has the other stator hub member in a remaining range.

An aspect of the present invention is a torque converter including the split molded integrated stator described above.

An aspect of the present invention is a method for manufacturing a split molded integrated stator being a stator including a stator hub, a large number of blades radially provided in a projecting manner at regular intervals on an outer periphery of the stator hub, and a stator core formed so as to surround outer ends of the respective blades, including a step of separately molding a front side stator member and a rear side stator member as two axially split members, respectively, and a step of joining the molded front side stator member and rear side stator member to be integrated.

### BRIEF DESCRIPTION OF THE DRAWINGS

FIG. 1 is a longitudinal sectional view of a stator at a first manufacturing stage in an embodiment of the present invention;

FIG. 2 is a front view of a rear side stator member of the same stator at the first manufacturing stage;

FIG. 3 is a wing section of a blade of the same stator at the first manufacturing stage;

FIG. 4 is a longitudinal sectional view of a stator at a second manufacturing stage in the same embodiment;

FIG. 5 is a wing section of a blade of the same stator at the second manufacturing stage;

FIG. 6 is a longitudinal sectional view of a stator at a first manufacturing stage showing another embodiment of the present invention;

FIG. 7 is a main part enlarged view showing an example of joining of a front side stator hub member and a rear side stator hub member in the embodiment of FIG. 6;

FIG. 8 is a longitudinal sectional view of a conventional ordinary stator.

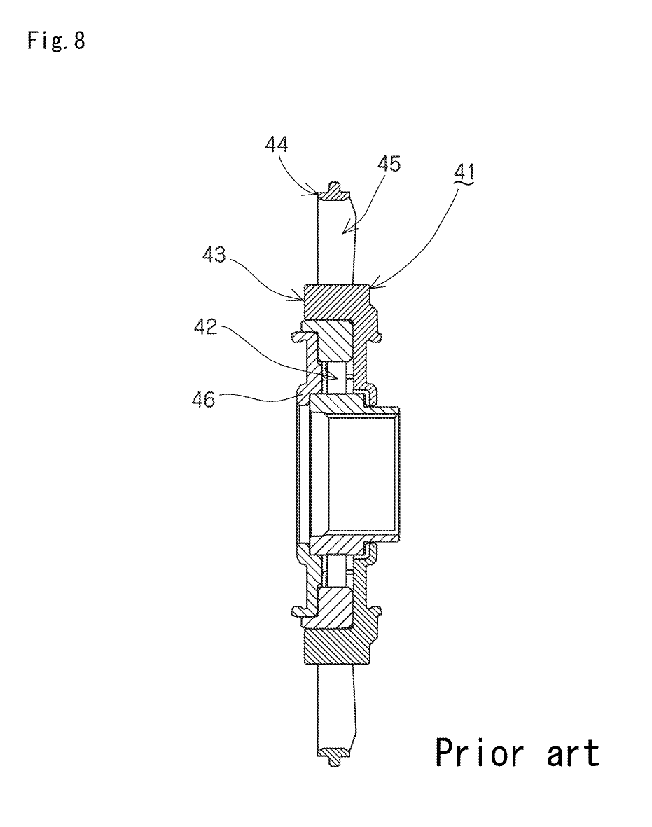

FIG. 9 is a front view of the stator in FIG. 6.

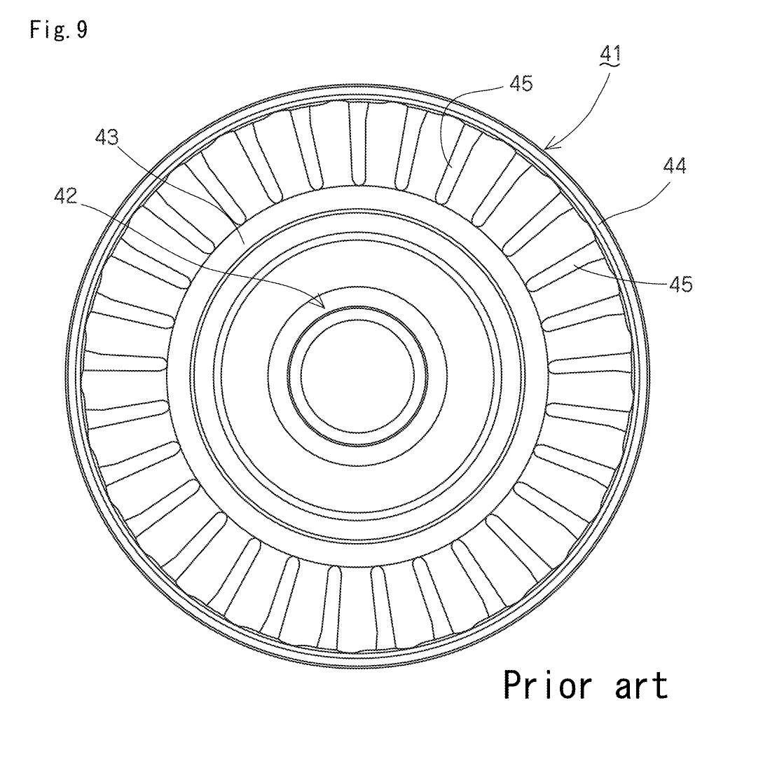

FIG. 10 is a wing section of a blade of the stator in FIG. 6;

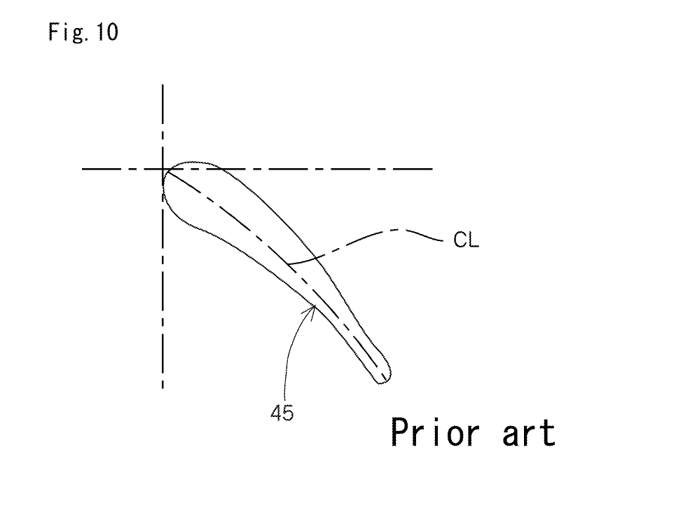

FIG. 11 is a schematic view of a die showing a procedure for axial releasing molding; and

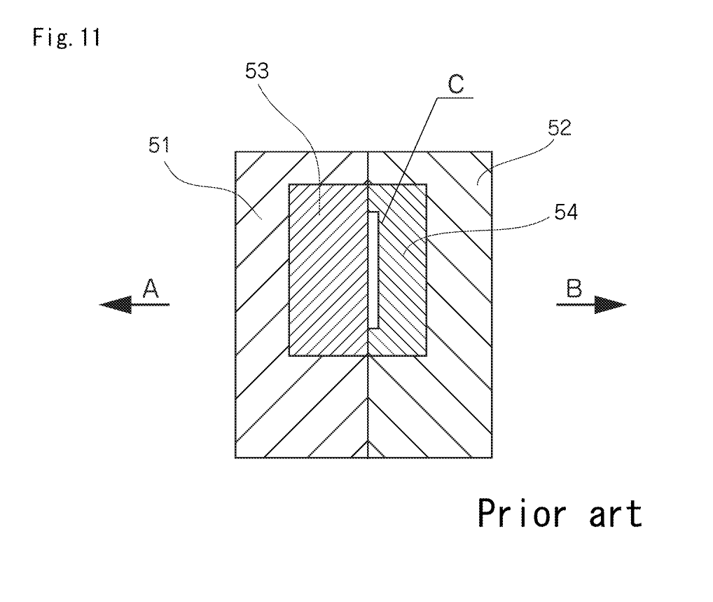

FIG. 12 is a schematic view of a die showing a procedure for radial releasing molding.

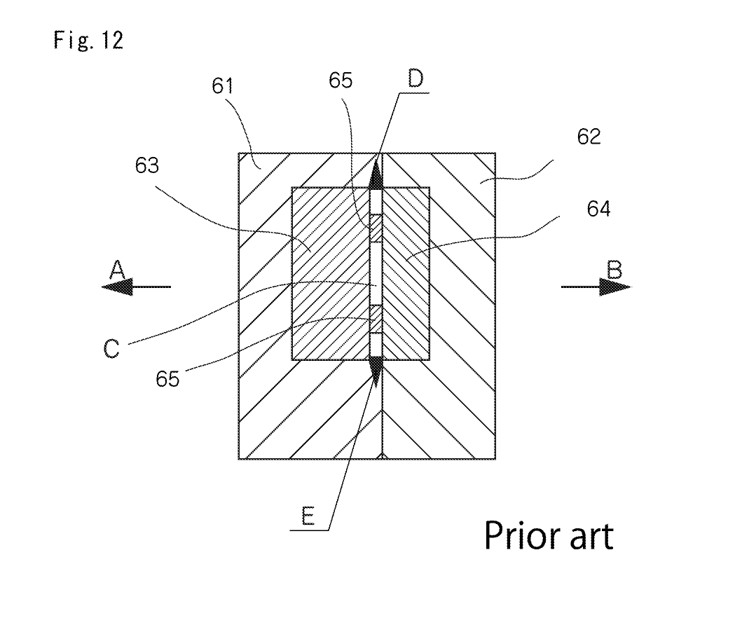

### DETAILED DESCRIPTION OF THE PREFERRED EMBODIMENTS

Hereinafter, stators according to embodiments of the present invention will be described in accordance with the drawings, but the present invention is not limited to such embodiments.

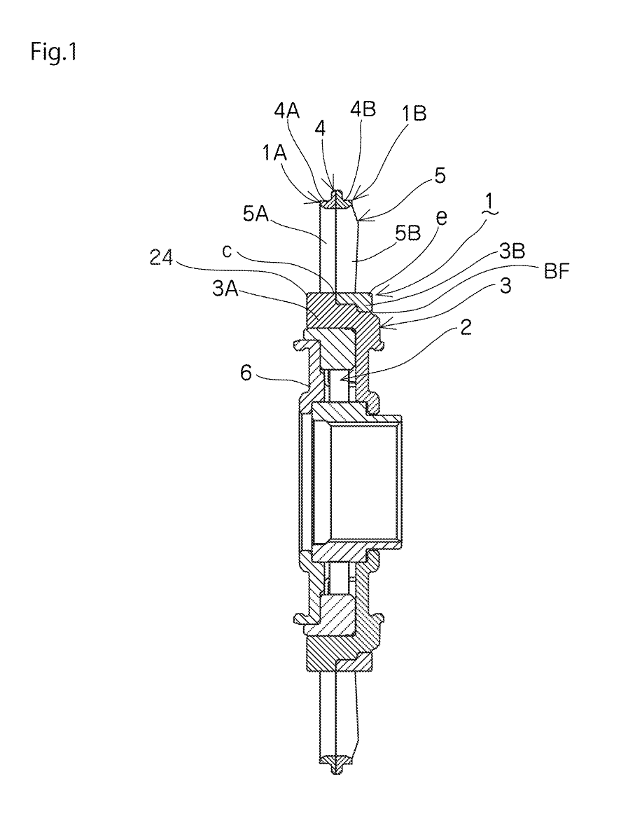

In the present application, a front-rear direction is defined with reference to FIG. 1, and “front” means a left-side direction in an axial direction of a stator in FIG. 1, and “rear” means a right-side direction of the same.

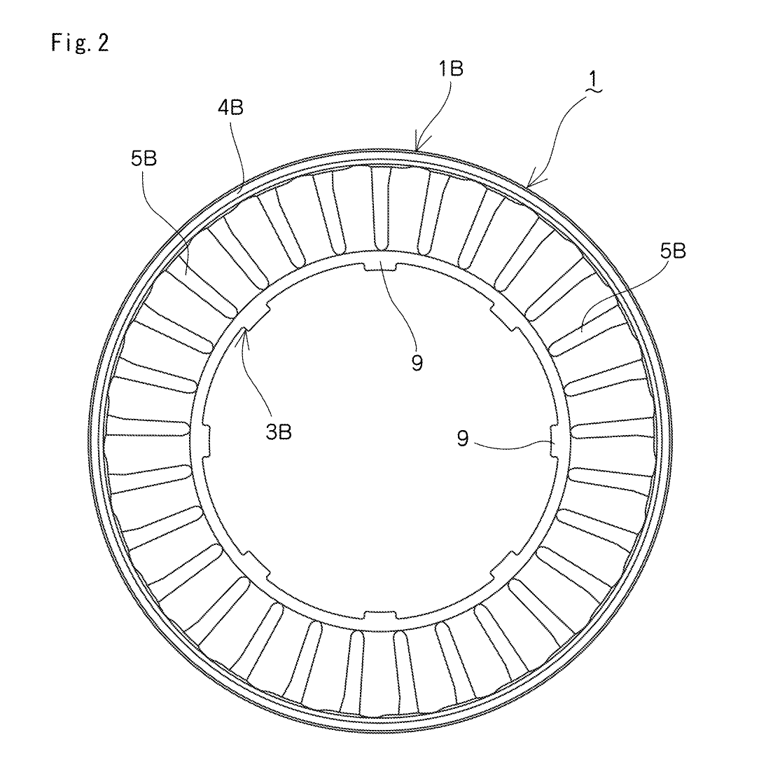

As shown in FIG. 1 and FIG. 2, the stator 1 is, for example, cast molded using an aluminum alloy or the like, and includes a stator hub 3 fixed to an outer periphery of a one-way clutch 2 for supporting on a stationary shaft (not shown), a stator core 4 formed out of the stator hub 3, blades 5 in predetermined shapes provided, between the stator core 4 and the stator hub 3, radially at regular intervals in a circumferential direction of the stator core 4 and the stator hub 3, and also, a retainer 6 is attached to a front side of the one-way clutch 2.

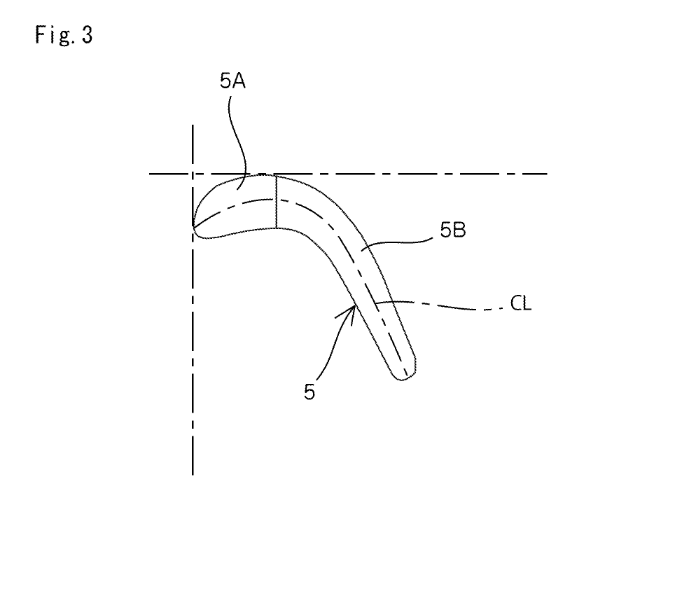

Moreover, as shown in FIG. 1 and FIG. 3, in the present embodiment, the stator 1 is, as a first manufacturing step, subjected to injection molding of axial releasing in a manner separated into a front side stator member 1A and a rear side stator member 1B such that the blades 5 are divided into two each in the front-rear direction (axial direction), the front side stator member 1A is composed of a front side stator hub member 3A, a front side stator core member 4A, and front side blade members 5A, and the rear side stator member 1B is composed of a rear side stator hub member 3B, a rear side stator core member 4B, and rear side blade members 5B.

The blade 5, in the present embodiment, has a large radius of curvature of its camber line CL. However, the blade 5, as described above, in the first manufacturing step, has a construction divided into the front side blade member 5A and the rear side blade member 5B.

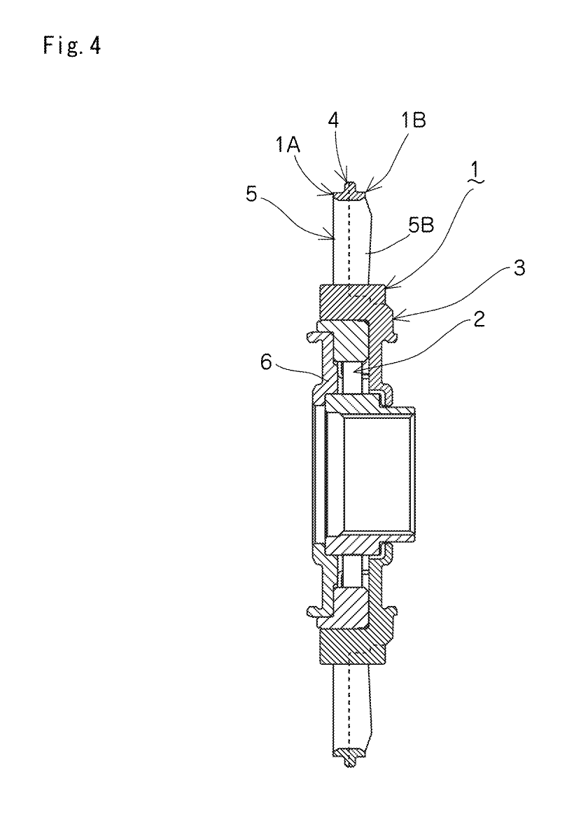

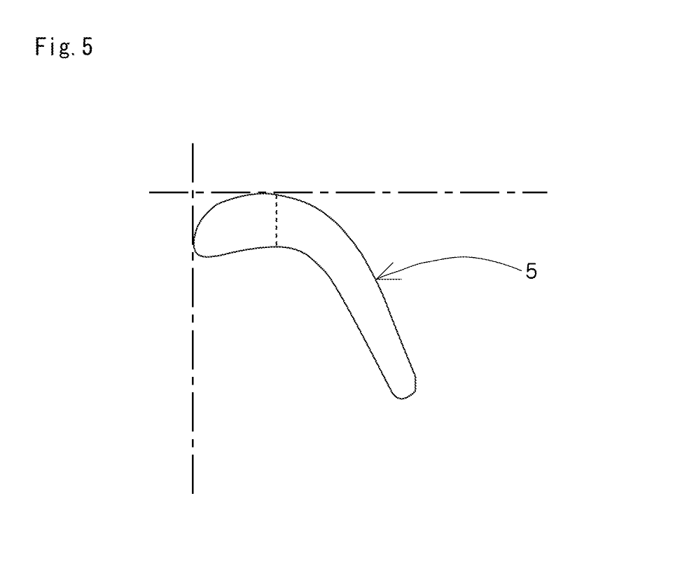

Next, as shown in FIG. 4 and FIG. 5, for the stator 1, the front side stator member 1A and the rear side stator member 1B described above are finally united by various joining means as a second manufacturing step, so as to be integrated in whole.

As the joining means, for example, as shown in FIG. 1, the front side stator member 1A and the rear side stator member 1B are caulked, in a contact part BF between the front side stator member 1A and the rear side stator member 1B, in a manner spaced at predetermined intervals in its circumferential direction. Also, as shown in FIG. 2, for whirl-stop between the front side stator member 1A and the rear side stator member 1B, for example, fitting projection portions 9 are provided at regular intervals on an inner periphery of the rear side stator member 1B, and in the front side stator member 1A, fitting recess portions (not shown) to be fitted with the fitting projection portions 9 are provided.

Also, the front side stator member 1A and the rear side stator member 1B are coupled by, as another joining means between both members 1A and 1B, engaging the front side stator member 1A and the rear side stator member 1B by a C-ring and making a pin stand in a penetrating manner from the front side stator member 1A to the rear side stator member 1B.

In addition, joining means other than those described above include mechanical joining such as press-fitting and metallurgical joining such as pressure welding.

Describing in greater detail a splitting form into the front side stator member 1A and the rear side stator member 1B in the first manufacturing step of the stator 1 in the present embodiment, as shown in FIG. 1 and FIG. 3, the stator core 4 and the blades 5 are longitudinally split in a radial direction in a manner divided into two nearly equal front and rear parts and divided into the front side stator core member 4A and the rear side stator core member 4B and into the front side blade members 5A and the rear side blade members 5B, and the stator hub 3 on an inner peripheral side has the rear side stator hub member 3B in a narrow range extending from an upper central part c to an upper rear-side corner portion e, and a wide range excluding the rear side stator hub member 3B is provided as the front side stator hub member 3A.

However, in the present invention, the splitting form of the stator 1 is not limited to the form described above, and may have any structure for splitting into two in the axial direction.

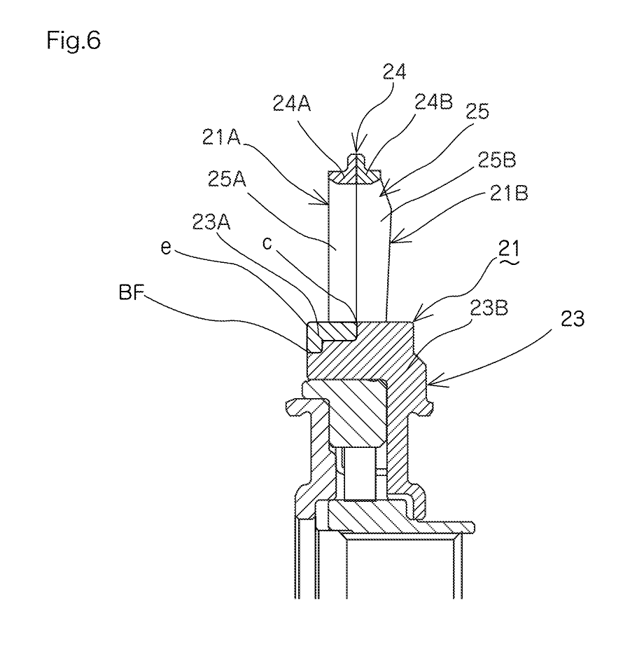

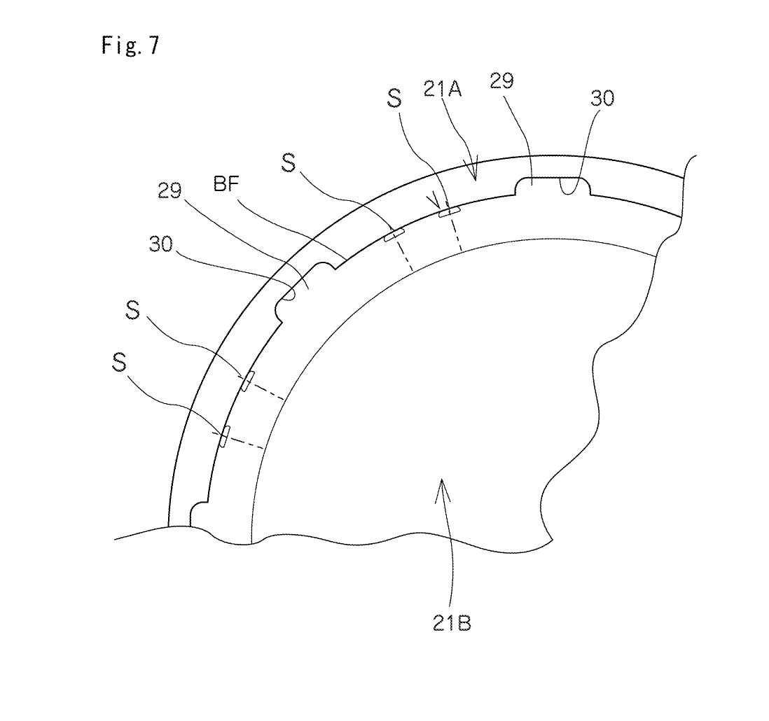

Describing another embodiment of the present invention, as shown in FIG. 6 and FIG. 7, the stator 21 has a splitting form that is opposite in the front-rear direction as compared with that of the stator 1 according to the embodiment described above. That is, the stator 21 is, as a first manufacturing step, subjected to injection molding of axial releasing in a manner separated into a front side stator member 21A and a rear side stator member 21B such that blades 25 are divided into two each in the front-rear direction (axial direction), and thus provided as a construction in which the front side stator member 21A has a front side stator hub member 23A, a front side stator core member 24A, and front side blade members 25A and the rear side stator member 21B has a rear side stator hub member 23B, a rear side stator core member 24B, and rear side blade members 25B.

Now describing a splitting form into the front side stator member 21A and the rear side stator member 21B in the first manufacturing step of the stator 21 in the present embodiment, the stator core 24 and the blades 25 are longitudinally split in a radial direction in a manner divided into two nearly equal front and rear parts and divided into the front side stator core member 24A and the rear side stator core member 24B and into the front side blade members 25A and the rear side blade members 25B, and the stator hub 23 on an inner peripheral side has the front side stator hub member 23A in a narrow range extending from an upper central part c to an upper front-side corner portion e, and a wide range excluding the front side stator hub member 23A is provided as the rear side stator hub member 23B.

Next, describing joining of the front side stator member 21A and the rear side stator member 21B as a second manufacturing step, as shown in FIG. 7, in a contact part BF between the front side stator member 21A and the rear side stator member 21B, fitting recess portions 30 are formed in the front side stator member 21A at regular intervals in a circumferential direction, and in the rear side stator member 21B, fitting projection portions 29 to be fitted with the fitting recess portions 30 are formed. Moreover, by fitting the fitting projection portions 29 and the fitting recess portions 30 with each other, a relative rotation between the front side stator member 21A and the rear side stator member 21B is prevented. Further, in sections between the parts where the fitting projection portion 29 and the fitting recess portion 30 are fitted with each other, caulking S is performed at two sites each. That is, in the present embodiment, the front side stator member 21A and the rear side stator member 21B are joined by fitting the fitting projection portions 29 and the fitting recess portions 30 with each other and the caulking S.

1. A split molded integrated stator being a stator including a stator hub, a large number of blades radially provided in a projecting manner at regular intervals on an outer periphery of the stator hub, and a stator core formed so as to surround outer ends of the respective blades, for which a front side stator member and a rear side stator member are respectively separately molded as two axially split members, and the front side stator member and the rear side stator member are then jointed to be integrated.

2. The split molded integrated stator according to claim 1, wherein as a splitting form into the front side stator member and the rear side stator member, the stator core and the blade are longitudinally split in a radial direction in a manner divided into two nearly equal front and rear parts and divided into a front side stator core member and a rear side stator core member and into a front side blade member and a rear side blade member, and the stator hub on an inner peripheral side has a rear side stator hub member in a range extending from an upper central part to an upper rear-side corner portion of the stator hub, and a remaining range excluding the rear side stator hub member is provided as a front side stator hub member.

3. The split molded integrated stator according to claim 1, wherein as a splitting form into the front side stator member and the rear side stator member, the stator core and the blade are longitudinally split in a radial direction in a manner divided into two nearly equal front and rear parts and divided into a front side stator core member and a rear side stator core member and into a front side blade member and a rear side blade member, and the stator hub on an inner peripheral side has a front side stator hub member in a range extending from an upper central part to an upper front-side corner portion of the stator hub, and a remaining range excluding the front side stator hub member is provided as a rear side stator hub member.

4. The split molded integrated stator according to claim 1, wherein the front side stator member and the rear side stator member are joined by fitting and caulking in a contact part of both members.

5. A torque converter comprising the split molded integrated stator according to claim 1.

6. A method for manufacturing a split molded integrated stator being a stator including a stator hub, a large number of blades radially provided in a projecting manner at regular intervals on an outer periphery of the stator hub, and a stator core formed so as to surround outer ends of the respective blades, comprising a step of separately molding a front side stator member and a rear side stator member as two axially split members, respectively, and a step of joining the molded front side stator member and rear side stator member to be integrated.

7. The split molded integrated stator according to claim 2, wherein the front side stator member and the rear side stator member are joined by fitting and caulking in a contact part of both members.

8. The split molded integrated stator according to claim 3, wherein the front side stator member and the rear side stator member are joined by fitting and caulking in a contact part of both members.

9. A torque converter comprising the split molded integrated stator according to claim 2.

10. A torque converter comprising the split molded integrated stator according to claim 3.
